(19) United States
(12) Patent Application Publication
(10) Pub. No.: US 2021/0095613 A1
(43) Pub. Date: Apr. 1, 2021

(54) CYLINDER BLOCK AND CYLINDER BLOCK COMBINED WITH CYLINDER LINER

(71) Applicants: HYUNDAI MOTOR COMPANY, Seoul (KR); KIA MOTORS CORPORATION, Seoul (KR)

(72) Inventors: Young Gi KIM, Seoul (KR); Jong Beom SEO, Yongin-si (KR); Byung Hyun LEE, Bucheon-si (KR); Myoung Ho LEE, Suwon-si (KR); Joong Hyun HWANG, Suwon-si (KR); Jin Woo CHO, Seongnam-si (KR); Dae Woong LEE, Gunpo-si (KR); Chang Min LEE, Hwaseong-si (KR)

(73) Assignees: HYUNDAI MOTOR COMPANY, Seoul (KR); KIA MOTORS CORPORATION, Seoul (KR)

(21) Appl. No.: 16/744,988

(22) Filed: Jan. 16, 2020

(30) Foreign Application Priority Data
Sep. 26, 2019 (KR) 10-2019-0118915

(51) Int. Cl. F02F 1/00; F16J 15/06

(52) U.S. Cl. CPC F02F 1/004; F02F 2001/008; F16J 15/06

(57) ABSTRACT

A cylinder block includes an extension portion that is shaped to extend toward the cylinder liner and is formed on an end portion of the cylinder block so as to form a surface contact with a head gasket. In particular, the cylinder liner includes an end portion forming an accommodation groove portion that is shaped to correspond to the extension portion, and a part of the end portion of the cylinder liner is supported on a circumferential surface of the extension portion and is linked to the accommodation groove portion. In addition, the part of the end portion of the cylinder liner forms a surface contact with the head gasket.

### CROSS REFERENCE TO RELATED APPLICATION

This present application claims priority to and the benefit of Korean Patent Application No. 10-2019-0118915, filed on Sep. 26, 2019, the entire contents of which are incorporated herein byreference

### FIELD

The present disclosure relates to a cylinder block and a cylinder block combined with a cylinder liner, which improve durability of an engine.

### BACKGROUND

The statements in this section merely provide background information related to the present disclosure and may not constitute prior art.

In the case of a cylinder block manufactured of aluminum alloy, a cylinder liner manufactured of cast iron is inserted into a cylinder bore in order to prevent a situation where an inner wall of a cylinder wears out.

However, we have discovered that because the cylinder block and the cylinder liner are formed of different materials, a level of combinability therebetween is low. Specifically, it causes a low-durability problem in a high-performance engine in which a combustion pressure is high. For example, a crack may occur in a part of a portion of the cylinder block that is brought into the cylinder liner.

The matters described above are intended merely to aid in the understanding of the background of the present disclosure, and are not intended to mean that the present disclosure falls within the purview of the related art that is already known to a person of ordinary skill in the art.

### SUMMARY

The present disclosure provides a cylinder block for an engine and a cylinder block combined with a cylinder liner, which improve durability of the engine by improving a structure in which the cylinder block and the cylinder line are combined.

According to an aspect of the present disclosure, A cylinder block for an engine includes an extension portion famed on an end portion of the cylinder block and configured to extend toward a cylinder liner, and the end portion of the cylinder block is configured to form a surface contact with a head gasket. In particular, the cylinder liner includes an end portion forming an accommodation groove portion that is shaped to correspond to the extension portion, and a part of the end portion of the cylinder liner is supported on a circumferential surface of the extension portion and is linked to the accommodation groove portion. Furthermore, the part of the end portion of the cylinder liner forms a surface contact with the head gasket.

In the cylinder liner, a protruding bead portion foamed on a bottom surface of the head gasket may be formed not to be positioned at a border point between the extension portion and the accommodation groove portion.

In one form, the extension portion of the cylinder block may be formed to extend in such a manner that a protruding bead portion formed on a bottom surface of the head gasket is positioned within an upper surface of the cylinder block.

In another form, a liner protrusion may be formed on an outer circumferential surface of the cylinder liner, and thus the liner protrusion may be shaped to be inserted into an inner circumferential surface of the cylinder block, and an outer circumferential surface of the accommodation groove portion may be formed without any liner protrusion thereon and may be combined with an inner circumferential surface of the extension portion.

In other form, a coating layer may be formed with the same or similar material as the extension portion and may be deposited on the outer circumferential surface of the accommodation groove portion.

In another form, a coating layer may be formed withf the same or similar material as the cylinder block and may be deposited on the outer circumferential surface of the cylinder liner.

In another aspect of the present disclosure, the extension portion and the accommodation groove portion may be formed in the shape of a ring with a rectangular cross section.

According to another aspect of present disclosure, the extension portion is formed in such a manner as to cover only a portion of an upper surface of the cylinder liner, and thus a flank surface of the accommodation groove portion is shaped to allow for a movement in the lateral direction, of the accommodation groove portion. As a result, engine durability can be improved by inhibiting or preventing a crack from occurring in border portions of the cylinder block and the cylinder liner that are brought into contact with each other.

Moreover, the protruding bead portion sits only on the upper surface of the cylinder block through the extension portion. As a result, the risk of leakage in the border portions of the cylinder block and the cylinder liner due to the pressing by the protruding bead portion can be prevented.

In addition, the coating layer that is formed of the same or similar as the extension portion is deposited on the circumferential surface of the accommodation groove portion that is brought into contact with the extension portion. As a result, performance in terms of combinability between the extension portion and the accommodation groove portion can be improved, and thus the cylinder block and the cylinder liner can be combined more firmly.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram schematically illustrating a structure in which a cylinder liner is combined with a cylinder block according to one form of the present disclosure, when viewed form above;

FIG. 2 is a cross-sectional diagram taken along line A-A in FIG. 1, for describing a structure in which the cylinder block and the cylinder liner are combined and a position at which a protruding bead portion on a head gasket is brought into contact with the cylinder block; and

FIGS. 3 and 4 are diagrams each illustrating a structure of a comparative example in which an extension portion and an accommodation groove portion according to the present disclosure are not provided.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

An exemplary form of the present disclosure will be described in detail below with reference to the accompanying drawings.

According to one form of the present disclosure, an engine has a structure in which a cylinder block 10 and a cylinder liner 20 are combined. Particularly, this structure in which a cylinder block 10 and a cylinder liner 20 are combined is improved by changing a shape of an upper end portion of the cylinder block 10 on which a head gasket 30 sits and a shape of an upper end portion of the cylinder liner 20.

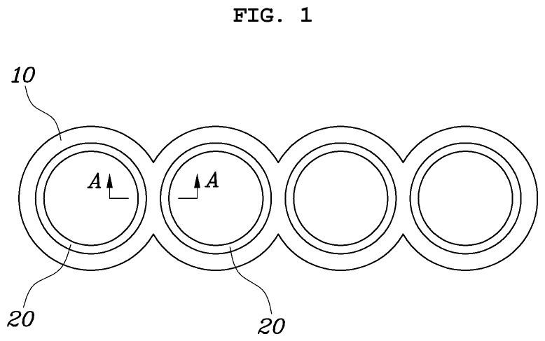

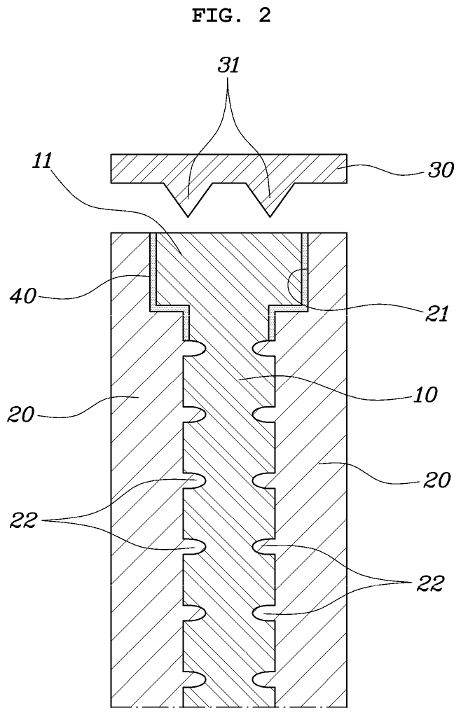

With reference to FIGS. 1 and 2, exemplary forms of the present disclosure are described in more detail. The cylinder liner 20 is provided within a cylinder bore formed in the cylinder block 10. The cylinder block 10 and a cylinder head are combined with the head gasket 30 in between. An extension portion 11 that is shaped to extend toward the cylinder liner 20 is formed on an upper end of the cylinder block 10, which is brought into surface contact with the head gasket 30.

Then, an accommodation groove portion 21 that is shaped to correspond to the extension portion 11 is formed in an end portion of the cylinder liner 20. A part of the end portion, which is supported on a circumferential surface of the extension portion 11 and is linked to the accommodation groove portion 21, is formed in such a manner as to be brought into surface contact with the head gasket 30.

The extension portion 11 and the accommodation groove portion 21 here may be formed in the shape of a ring with a rectangular cross section.

That is, the upper end of the cylinder block 10 is formed to extend toward the cylinder liner 20 and thus is shaped to surround the upper end of the cylinder liner 20. This improves combinability between the cylinder block 10 and the cylinder liner 20.

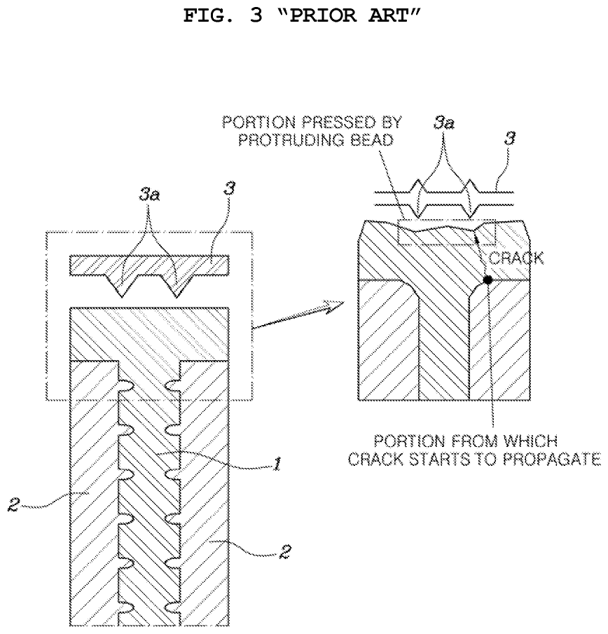

Accordingly, in order to further improve the combinability between the cylinder block 10 and the cylinder liner 20, as illustrated in FIG. 3, it may be considered that an extension portion (whose reference number is omitted) is shaped to cover an entire upper surface of a cylinder liner 2. However, when this applies to high-performance engine in which a combustion pressure is high, a crack may occur in a border part of a lower end portion of a cylinder block 1 that is brought into contact with the cylinder liner 2.

Therefore, in one form of the present disclosure, the extension portion 11 is formed on the cylinder block 10 in such a manner as to cover only a portion of an upper surface of the cylinder liner 20. Thus, a structure is provided in which the accommodation groove portion 21 formed in the cylinder liner 20 surrounds the extension portion 11. Accordingly, a flank surface of the accommodation groove portion 21 allows for a movement in the lateral direction, of the extension portion 11.

With this structure, a crack is prevented from occurring in border portions of the cylinder block 10 and the cylinder liner 20 that are brought into contact with each other. Thus, engine durability is improved.

Furthermore, a structure is provided in which the extension portion 11 is formed in such a manner that a protruding bead portion 31 formed on a bottom surface of the head gasket 30 is not positioned at a border point where the extension portion 11 and the accommodation groove portion 21 are brought into contact with each other.

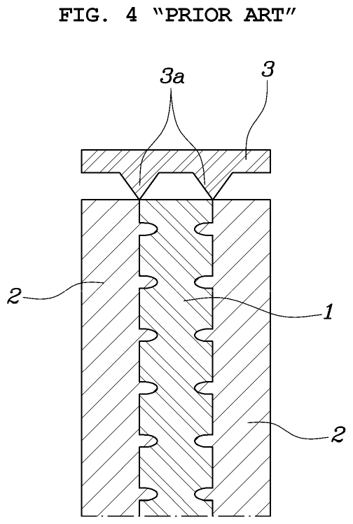

For example, the cylinder block 10 is made of aluminum, and the cylinder liner 20 is made of cast iron. However, as illustrated in FIG. 4, a protruding bead portion 3a formed on a head gasket 3 sits on and presses against border portions of upper surfaces of the cylinder block 1 and the cylinder liner 2 that are formed of different materials. Thus, a leakage problem can occur.

Accordingly, according to one foam of the present disclosure, the extension portion 11 can be formed with a structure in which the protruding bead portion 31 formed on the head gasket 30 does not sit at a border point where the cylinder block 10 and the cylinder liner 20 are brought into contact with each other.

As an desirable example, as illustrated in FIG. 2, the extension portion 11 may be formed to extend in such a manner that the protruding bead portion 31 on the bottom surface of the head gasket 30 is positioned within an upper surface of the cylinder block 10.

Therefore, the protruding bead portion 31 sits only on the upper surface of the cylinder block 10, and thus a risk that the leakage occurs in the border portions of the cylinder block 10 and the cylinder liner 20 due to the pressing by the protruding bead portion 31 is prevented.

Furthermore, according to another form of the present disclosure, a liner protrusion 22 is famed on an outer circumferential surface of the cylinder liner 20. Thus, for combination, the liner protrusion 22 is shaped to be inserted into an inner circumferential surface of the cylinder block 10.

Then, a structure is employed in which an outer circumferential surface of the accommodation groove portion 21 is smoothly formed without any liner protrusion 22 thereon and is combined with an inner circumferential surface of the extension portion 11.

That is, the liner protrusion 22 is formed on an outer peripheral surface of the cylinder liner 20 and is inserted into an inner peripheral surface of the cylinder block 10, and thus the combinability between the cylinder liner 20 and the cylinder block 10 is improved.

However, as illustrated in FIG. 4, when a liner protrusion (whose a reference number is omitted) is famed on the cylinder liner and is inserted into the cylinder block 1, the protruding bead portion 3a formed on the head gasket 3 presses against a portion of the cylinder block 1 on the liner protrusion, and thus a crack in and damage to the portion of the cylinder block 1 occur. As a result, problems of decreasing the engine durability occur such as an increase in the risk of leakage.

Accordingly, according to one form of the present disclosure, as illustrated in FIG. 2, in order to decrease the risk of leakage, the liner protrusion 22 is configured not to be formed on a portion of the outer peripheral surface of the cylinder liner 20, which is positioned on an outer peripheral surface of the accommodation groove portion 21 close to the head gasket 30.

However, because the liner protrusion 22 is not formed on the outer circumferential surface of the accommodation groove portion 21, a coating layer 40 may be instead formed on the accommodation groove portion 21 in order to improve the combinability with the extension portion 11.

It is desirable that the coating layer 40 that is formed of the same or similar material as the extension portion 11 is deposited on the outer circumferential surface of the accommodation groove portion 21.

That is, in a case where the extension portion 11 is formed of the same aluminum as the cylinder block 10, the coating layer 40 formed of aluminum is deposited on a circumferential surface of the accommodation groove portion 21 that is brought into contact with the extension portion 11. Thus, performance in terms of the combinability between the extension portion 11 and the accommodation groove portion 21 is improved.

In this manner, the coating layer 40 is not deposited on a portion of the outer peripheral surface of the outer peripheral surface, which has a relatively high level of combinability due to the liner protrusion 22. However, the coating layer 40 is deposited only on a portion which has a relatively low level of combinability because the liner protrusion 22 is not formed thereon. Thus, the cost can be saved by reducing the size of the coating layer 40 while providing an improvement in the performance in terms of the combinability between the cylinder block 10 and the cylinder liner 20.

Of course, although not illustrated, the coating layer 40 may be deposited on the entire cylinder liner 20, as well as on the accommodation groove portion 21.

That is, the coating layer 40 that is formed of the same or similar material as the cylinder block 10 is deposited on the outer circumferential surface of the cylinder liner 20, and thus the performance in terms of the combinability between the cylinder block 10 and the cylinder liner 20 is further improved.

As described above, according to one form of the present disclosure, the extension portion 11 is formed to cover only a portion of the upper surface of the cylinder liner 20, and thus the flank surface of the accommodation groove portion 21 is shaped to allow for the movement in the lateral direction, of the extension portion 11. Accordingly, a crack can be prevented from occurring in the border portions of the cylinder block 10 and the cylinder liner 20 that are brought into contact with each other, thereby increasing the engine durability.

Moreover, the protruding bead portion 31 sits only on the upper surface of the cylinder block 10 through the extension portion 11. Thus, the risk of leakage in the border portions of the cylinder block 10 and the cylinder liner 20 due to the pressing by the protruding bead portion 31 is prevented.

In addition, the coating layer 40 that is formed of the same or similar material as the extension portion 11 is deposited on the circumferential surface of the accommodation groove portion 21 that is brought into contact with the extension portion 11. Thus, the performance in terms of the combinability between the extension portion 11 and the accommodation groove portion 21 is improved. As a result, the cylinder block 10 and the cylinder liner 20 can be combined more firmly.

On the other hand, only the specific examples according to the present disclosure are described in detail, but it is apartment to a person of ordinary skill in the art that various modification and alterations are possible within the scope of the technical idea of the present disclosure.

What is claimed is:

1. A cylinder block for an engine, the cyliner block comprising:
an extension portion formed on an end portion of the cylinder block and configured to extend toward a cylinder liner, the end portion of the cylinder block configured to form a surface contact with a head gasket,
wherein the cylinder liner includes an end portion forming an accommodation groove portion that is shaped to correspond to the extension portion, and a part of the end portion of the cylinder liner is supported on a circumferential surface of the extension portion and is linked to the accommodation groove portion, and
wherein the part of the end portion of the cylinder liner forms a surface contact with the head gasket.

2. The cylinder block according to claim 1, wherein a protruding bead portion formed on a bottom surface of the head gasket is not positioned at a border point between the extension portion and the accommodation groove portion.

3. The cylinder block according to claim 1, wherein a protruding bead portion formed on a bottom surface of the head gasket is positioned within an upper surface of the cylinder block.

4. The cylinder block according to claim 3, wherein a liner protrusion is famed on an outer circumferential surface of the cylinder liner, and the liner protrusion is shaped to be inserted into an inner circumferential surface of the cylinder block, and
wherein an outer circumferential surface of the accommodation groove portion is formed without any liner protrusion thereon and is combined with an inner circumferential surface of the extension portion.

5. The cylinder block according to claim 4, wherein a coating layer formed with the same or similar material as the extension portion is deposited on the outer circumferential surface of the accommodation groove portion.

6. The cylinder block according to claim 4, wherein a coating layer formed with the same or similar material as the cylinder block is deposited on the outer circumferential surface of the cylinder liner.

7. The cylinder block according to claim 1, wherein the extension portion and the accommodation groove portion are foiled in a shape of a ring with a rectangular cross section.

8. A cylinder block combined with a cylinder liner for an engine, comprising: an end portion forming an accommodation groove portion configured to accomodate an extension portion formed in an end portion of a cylinder block,
wherein the extension portion is shaped to extend toward the cylinder liner and forms a surface contact with a head gasket, and
wherein a part of the end portion of the cylinder liner is supported on a circumferential surface of the extension portion and is linked to the accommodation groove portion, forming a surface contact with the head gasket.
